(19) United States
(12) Patent Application Publication
(10) Pub. No.: US 2008/0141587 A1
(43) Pub. Date: Jun. 19, 2008

(54) Planter container inserts

(76) Inventor: Lawson Guthrie, (US)

Correspondence Address: Lawson Guthrie, 14742 NW Vance Drive, Portland, OR, 97229, US

(21) Appl. No.: 11/975,624

(22) Filed: Oct. 22, 2007

Related U.S. Application Data
(60) Provisional application No. 60/874,906, filed on Dec. 15, 2006.

(51) Int. Cl. A01G 9/02

(52) U.S. Cl. 47/86

(57) ABSTRACT

A planter insert extends the usefulness of a planter by creating a plurality of adjoined containers that fit within and conform to the inside shape of a planter, substantially filling its opening. The containers may be of uniform design and therefore portable and swappable, which facilitates modifying the arrangement of plants including those with different soil requirements and growing seasons. The containers may be adjoined using a locking system, a coupling system or any other means. A set of containers may be designed to fit around another object, such as an independent or center container of a different shape and size. Planter inserts provide maximum portability while minimizing wasted space often caused by gaps or support systems.

This application is a Non-Provisional Application claiming priority from U.S. Provisional Application 60/874,906 filed Dec. 15, 2006.

### BACKGROUND OF THE INVENTION

1. Field of the Invention

This invention relates to indoor and outdoor planters commonly used in or around households and commercial buildings.

2. Description of Related Art

Planters and planter supports face the challenge of maximizing planter portability and configurability while also minimizing wasted space from support structures or gaps.

Grzegorz Trabka U.S. Pat. No. 6,901,700 B2 utilizes a support structure within a planter for removable pots with the remaining area in a fixed configuration with soil and plants.

Leon E. Laux U.S. Pat. No. 4,048,754 defines a custom planter box with supports for removable pots.

Carlos Gonzalez, Sr. U.S. Pat. D502,794 S defines an equally subdivided planter cart as a support structure for removable pots.

Ronald M. Caird U.S. Pat. No. 5,094,060 illustrates the design of a basket and support structure to hold removable pots.

Abraham I. Tenzer and Jes S. Baru Des. 268,337 defines the ornamental design for a collection of custom planters with an elevated center pot.

Curtis J. Bouler U.S. Pat. No. 6,269,589 B1 utilizes containers as planters for trees, poles and other vertical surfaces.

### SUMMARY OF THE INVENTION

The present invention extends the usefulness of a planter by creating a plurality of container inserts 10 that substantially hold its contents. The planter acts as the outer shell and may be decorative, whereas the plurality of container inserts 10 may be concealed or obscured from general view. A container insert 20 may be portable and swappable, which facilitates modifying the arrangement of plants including those with different soil requirements and growing seasons.

A plurality of container inserts 10 may be designed in a variety of planter insert configurations and may substantially fill the top surface area of a planter. The plurality of container inserts 10 may use nominal to no support structures and may use a friction fit and/or a taper lock to hold the plurality of container inserts 10 in place. Designing the plurality of container inserts 10 to fit within or conform to the general inside shape of a planter, provides maximum portability while minimizing wasted space often caused by gaps or support systems.

### BRIEF DESCRIPTION OF THE DRAWINGS

The following definitions are used to describe components of a suitable embodiment of Planter Container Inserts.

10—A suitable embodiment of a plurality of container inserts

12—A suitable embodiment of a plurality of container inserts 10 with an Independent Vessel 30

20—A suitable embodiment of one of the plurality of container inserts 10

21—A container insert 20 in a single-row configuration or in the row closest to the inside wall of the planter.

22—First Side Portion of a suitable embodiment of a container insert 20

23—A container insert 20 in a multi-row configuration beyond the single-row configuration and single-row container insert 21

24—Second Side Portion of a suitable embodiment of a container insert 20

26—Third Side Portion of a suitable embodiment of a container insert 20. This may also refer to the Front of the container insert 20.

28—Bottom Side Portion of a suitable embodiment of a container insert 20

29—Back Side Portion of a suitable embodiment of a container insert 20

30—Independent Vessel

32—Circular Independent Vessel cavity

33—Circular Independent Vessel

34—Square Independent Vessel cavity

35—Square Independent Vessel

40—Removably Coupled

42—Lip Lock

44—Standing Male Coupler

46—Standing Female Coupler

48—Contoured edge

50—Drip Irrigation supports

52—Notches to support drip system tubing

54—A larger radius to create a gap for drip system tubing when paired with another of the plurality of container inserts 20.

60—Drainage holes

FIG. 1 shows the Front or Third Side Portion 26 view of a suitable embodiment of a container insert 20.

FIG. 2 shows a Back Side Portion 29 view of a suitable embodiment of a container insert 20

FIG. 3 shows a First Side Portion 22 view of a suitable embodiment of a container insert 20 and a Lip Lock 42

FIG. 4 shows a Second Side Portion 24 view of a suitable embodiment of a container insert 20.

FIG. 5 shows the top view of a suitable embodiment of two container inserts 20 coupled outside the planter in a Front-to-Back Contoured Fit.

FIG. 6 shows a suitable embodiment of a coupling system using a Standing Male Coupler 44 and a Standing Female Coupler 46.

FIG. 7 shows a suitable embodiment of a plurality of container inserts 12 with a circular Independent Vessel cavity 32

FIG. 8 completes FIG. 7 and the planter insert configuration by adding the circular Independent Vessel 33

FIG. 9 shows a suitable circular planter insert configuration with a plurality of container inserts 10

FIG. 10 shows a suitable circular, multi-row planter insert configuration with two complimentary designs of container inserts 21 and 23.

FIG. 11 shows a suitable square planter insert configuration with a plurality of container inserts 10

FIG. 12 shows a suitable rectangular planter insert configuration with a plurality of container inserts 10

FIG. 13 shows a suitable circular configuration with a plurality of container inserts 12 and an Independent Vessel cavity 32

FIG. 14 shows a suitable circular configuration with a plurality of container inserts 12 and a square Independent Vessel cavity 34

FIG. 15 shows a suitable square configuration with a plurality of container inserts 12 and a circular Independent Vessel cavity 32

FIG. 16 shows a suitable circular and multi-type planter insert configuration with a plurality of container inserts 10

### DESCRIPTION OF A SUITABLE EMBODIMENT

This invention is described with respect to the preferred physical embodiments constructed in accordance herewith. It will be apparent to those skilled in the art that various modifications and improvements may be made without departing from the scope and spirit of the invention. Accordingly, the invention is not limited by the specific embodiments illustrated and described, but only by the scope of the appended claims.

1. General Description

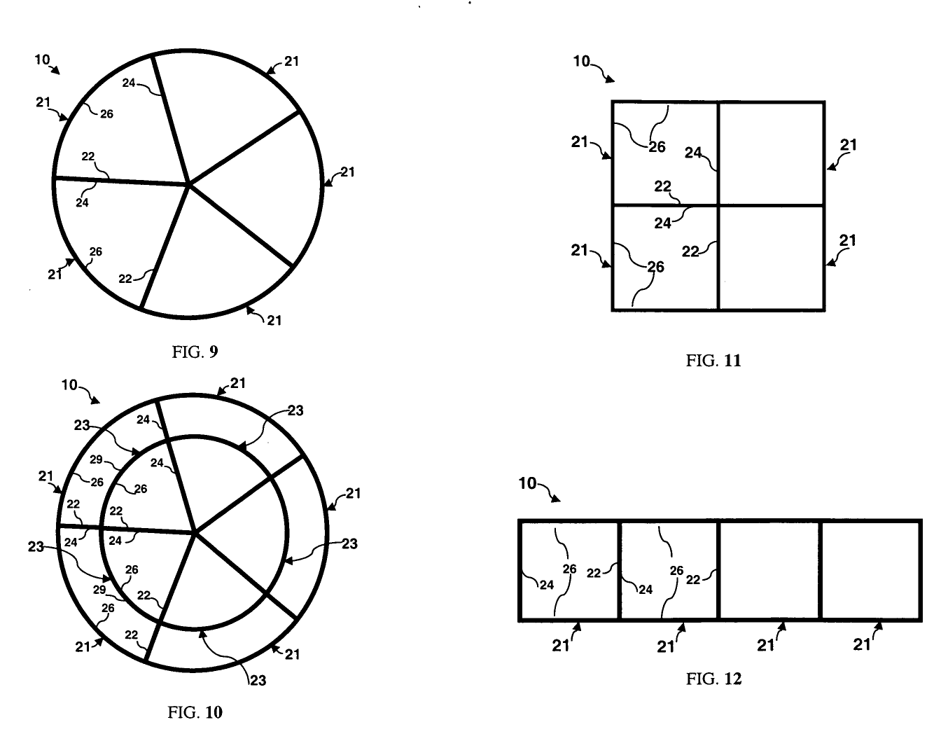

The present invention relates to a plurality of container inserts 10 for inserting into a planter. The plurality of container inserts 10 may conform to the general inside shape of the planter in a variety of planter insert configurations FIG. 9-16 and provide improved redesign and portability while minimizing wasted space sometimes caused by gaps and support systems.

The general purpose of a container insert 20 may be the same as that of a typical flower pot, which is to hold a plant(s) and soil. Optionally, it may hold artificial plants or any other object that may be placed in a planter. The container insert 20 may be minimally visible once inside the planter. The container insert 20 may be portable and reusable. The plurality of container inserts 10 within a target planter insert configuration may be of uniform size and therefore swappable and stackable.

2. Suitable Planter Insert Configurations

The plurality of containers 10 may be designed to support a target planter insert configuration, design or pattern within a planter or collection of planters. The planter insert configuration may be populated exclusively with a plurality of container inserts 10. The planter insert configuration may also be designed with an Independent Vessel(s) or some other object, most suitably a center Independent Vessel 30.

A full or partial planter insert configuration for a plurality of container inserts 10 may optionally be molded together. This may also include subdividing the inside of a container insert 20 into multiple compartments.

Planter: The term planter is well understood as a container for plants, typically decorative in nature and commonly used in or around households and commercial buildings. The planter itself may be circular, oval, square, rectangular or of some other shape. The planter may be permanent/fixed, temporary/movable, hanging, or of some other design.

A suitable planter insert configuration for circular planters may include a plurality of pie shaped container inserts 10 as shown in FIG. 9.

A suitable planter insert configuration for square planters is illustrated by a plurality of container inserts 10 in FIG. 11.

A suitable planter insert configuration for rectangular planters is illustrated by a plurality of container inserts 10 in FIG. 12.

Generally Conforms to the Inside Shape of a Planter: An exemplary planter insert configuration of a plurality of container inserts 10 may generally conform to the inside shape of a planter, whereby the inside measurements of the planter are substantially the same as the outside measurements of the plurality of container inserts 10.

Substantially Fills the Top Surface Area of a Planter: An exemplary completed planter insert configuration may substantially fill the top surface area of the planter, where the top inside measurements of the planter are substantially the same as the top outside measurements of the plurality of container inserts 10. The plurality of container inserts 10 may visibly fill the area of the planter open to the elements and may minimize or altogether eliminate any wasted space from support structures or gaps.

As illustrated in FIG. 8, the plurality of container inserts 12 with Independent Vessel 33 substantially fill the top surface area of the planter. Further exemplary planter insert configurations are shown in FIG. 9-16 when Independent Vessel cavities 32 and 34 are filled with an appropriate Independent Vessel 30.

Container inserts 20 may include a lip extension, suitably ¼ to ¾ inch, at the top edge of the Third Side Portion 26 to fill minor gaps between the plurality of container inserts 10 and the inside wall of the planter. The Lip Extension may be flat, curved or of any other shape to complement the rim of the planter. If the plurality of container inserts 10 is tight-fitting, the lip extension may rest on the top rim of the planter. The lip extension may further accommodate minor deviations from a broad range of planter manufacturers.

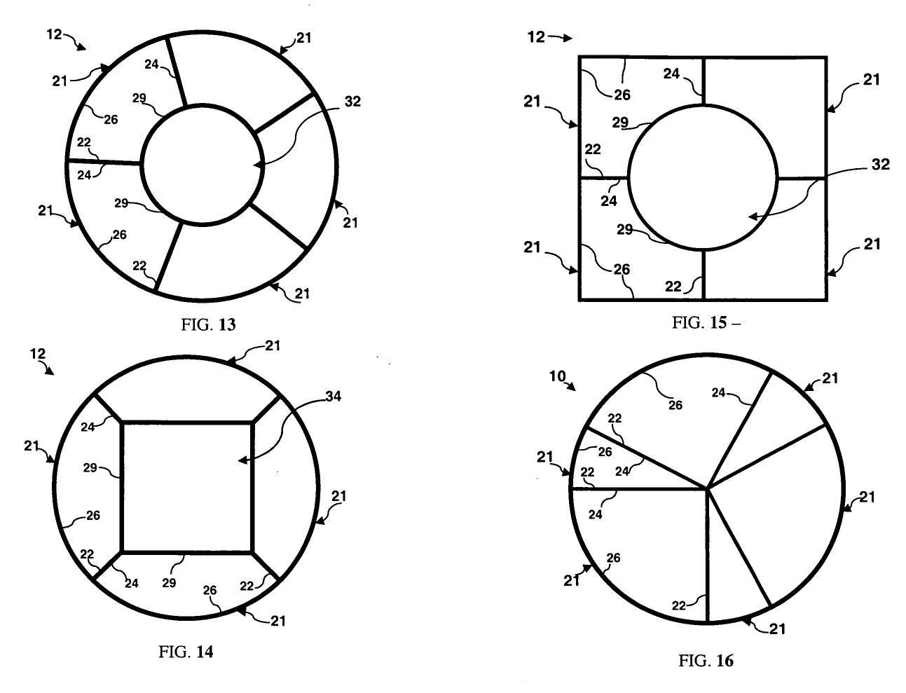

Uniform Design: The plurality of container inserts 10 within a planter insert configuration may be of different shapes and sizes. Most suitably, container inserts 20 may be of uniform dimension by subdividing the top surface area of the planter into equal segments FIG. 9, 11-12. The uniform design may also apply to multi-row configurations FIG. 10 and planter insert configurations with an Independent Vessel(s) 30 FIG. 13-15.

Alternate and also suitable planter insert configurations may include a few uniform designs. A suitable multi-type configuration with multiple uniform designs is illustrated in FIG. 16.

Minimal Support Structures: A completely populated planter insert configuration may minimize or altogether eliminate support structures to secure the plurality of container inserts 10 within the planter.

There may be implementations where nominal support would be advantageous. An example may include partial-depth implementations where nominal support beneath the plurality of container inserts 10 would aid when swapping individual container inserts 20 into or out of the planter.

Tight-Fitting and Friction Fit: The plurality of container inserts 10 may conform to the general inside shape of the planter and be tight-fitting. Container inserts 20 may be held in place or secured by gravity within the planter. For tapered planters, tight-fitting may also be referred to as a friction fit or taper lock caused by interference of the two tapered shapes colliding.

The plurality of container inserts 10 may use a locking or coupling system to ensure a tight fit of the planter insert configuration within the planter.

Varied Quantity of Container Inserts 20: The number of container inserts 20 may vary depending on the design and size of the planter For example, instead of five container inserts in FIG. 9, other suitable planter insert configurations may include four, six, seven or any other suitable number.

In large planters, multi-row configurations may be advantageous. A multi-row configuration with container inserts 21 and 23 is illustrated in FIG. 10. Each row may have its own design and may also use multiple types of container inserts 20 within a row to complete the planter insert configuration.

Independent Vessel: Planter insert configurations may include an Independent Vessel 30 around which a plurality of container inserts 12 is designed. The Independent Vessel 30 may be located anywhere in the planter insert configuration, such as off to a side or towards the back, but most suitably will be in the center. The Independent Vessel 30 may serve the same general purpose as a container insert 20 which is to hold a plant(s) and soil, or any other object that may be placed in a planter.

The Independent Vessel may be fixed within the planter or removable and therefore replaceable in the planter insert configuration.

The Independent Vessel 30 may be elevated to allow improved visibility of its contents.

The Independent Vessel 30 may be of any shape, though most suitably will be circular 33 or square 35.

Suitable embodiments of a plurality of container inserts 12 with an Independent Vessel cavity 32 and 34 are shown in FIGS. 13-15. Multi-row FIG. 10 and multi-type FIG. 16 configurations may also include an Independent Vessel 30.

The Independent Vessel 30 may complete a planter insert configuration when placed in an Independent Vessel cavity 32 & 34 formed by a plurality of container inserts 20.

There may be more than one Independent Vessel 30 in a planter insert configuration.

Visibility: A plurality of container inserts 10 may be concealed or obscured from general view so as not to detract from the aesthetics of the planter and plants.

3. Container Insert Characteristics

The shape and size of the container insert 20 may be determined by the shape and size of the target planter(s) and the target planter insert configuration.

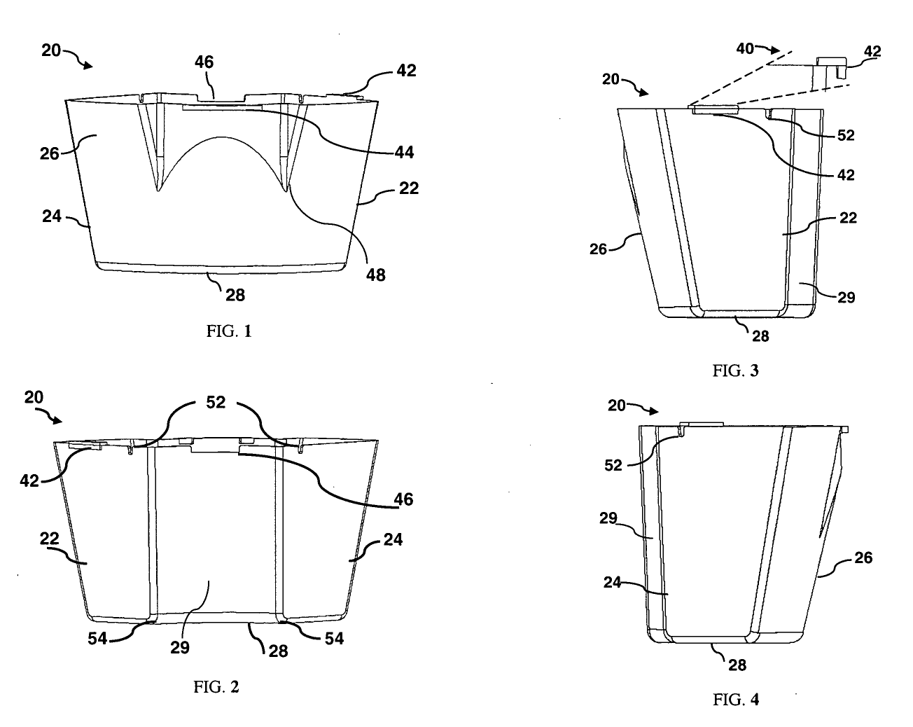

General Shape: The container insert 20 may have any number of sides, but most suitably will have a Bottom Side-Portion 28 and at least two side portions: a First Side Portion 22, a Second Side Portion 24 and suitably at least one Third Side Portion 26. A suitable embodiment is illustrated in FIG. 1-4.

The Bottom Side Portion 28, is the bottom of the container when in a vertical position and has contact with the First 22, Second 24 and suitably Third 26 Side Portions. Additional side portions may be used.

The container insert 20 may additionally have a Back Side Portion 29, most suitably with Independent Vessel and multi-row configurations FIG. 2-4, 10, 13-15,

Single-Row Container Insert 21: In a single-row configuration, at least one Side Portion of the container insert 21 may face or have contact with the inside wall of the planter, suitably the Third Side Portion 26 in FIGS. 9, 11-16.

Multi-Row Container Insert 23: In a multi-row configuration, the outer most row of container inserts 21 may follow the same principles as a single-row configuration with respect to its relationship with the planter. The inside row(s) of container inserts 23 in a multi-row configuration may not have contact with the inside wall of the planter but rather with the next row in succession to the outermost row of container inserts 21. Most suitably the Third Side Portion 26 of container insert 23 will face the Back Side Portion 29 of container insert 21 as illustrated in FIG. 10 in a two row configuration.

Stackable: The uniform shape allows the plurality of container inserts 10 to be stackable. Multi-type configurations may also be stackable. This may be valuable so as to minimize production, packaging, shipping and storage costs. The uniform shape also allows each design of a plurality of container inserts 10 to more easily be swapped into and out of planters.

Locking System: A container insert 20 may include a locking system to secure or stabilize one of the plurality of container inserts 10 to another of the plurality of container inserts 10. A suitable embodiment of a locking system is the Lip Lock 42 as shown in FIG. 2, 3, 7-8.

The Lip Lock 42 may enable container inserts 20 to remain level within the planter, even when support beneath the Bottom Side Portion 28 is uneven.

The Lip Lock may also be used to connect container inserts 21 and 23 in a multi-row configuration.

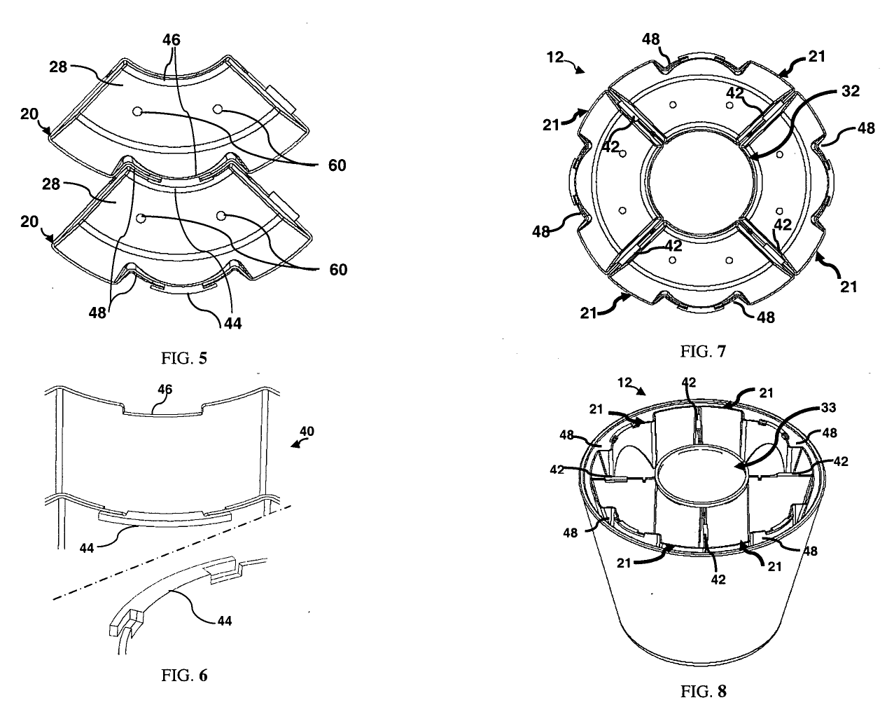

Coupling System: A container insert 20 may use a coupling system to adjoin one of the plurality of container inserts 10 to another of the plurality of container inserts 10. A suitable embodiment of a coupling, system is provided in FIG. 5-6 wherein the Standing Male Coupler 44 is joined with a Standing Female Coupler 46 to provide stability for multiple container inserts 20 when freely standing outside of the planter.

Front-to-Back Contoured Fit: A container insert may use a Front-to-Back Contoured Fit when set outside the planter. This may add greater stability or make better use of available space. A suitable embodiment of a Front-to-Back Contoured Fit is shown in FIG. 5 wherein the Third Side Portion 26 has a contoured edge 48 to allow a tight fit with the Back Side Portion 29 of another container insert 20 outside the planter.

Extraction System: Container inserts 20 may include an extraction system to facilitate their removal from the planter. This may be necessary when the plurality of container inserts 10 is tight-fitting within a planter. A suitable embodiment is shown in FIG. 1, 5, 7-8 where the contoured edge 48 facilitates inserting a finger(s) or other object(s) between the container insert 20 and the inside wall of the planter.

Varied Depth: Container inserts 20 and planter insert configurations may be designed to a full or partial depth within the planter(s).

Support for Drip System Tubing: Support for drip irrigation tubing may be added to the container insert 20. A suitable embodiment is shown in FIG. 2-4 with the addition of notches 52 to the top of the container insert 20 to hold and conceal the tubing. Independently, notches 52 may also facilitate overflow between container inserts 20 when watered.

Container inserts 20 may be designed to enable drip system tubing to come up from beneath or between a plurality of container inserts 10. A suitable embodiment is shown in FIG. 2 where a larger radius 54 on the corners of paired container inserts 20 produces a gap for the drip system tubing.

Drainage Holes: Container inserts 20 may include drainage holes 60. A suitable embodiment is shown in FIG. 5.

4. Materials used in Container Inserts 20

Container inserts 20 can be made with a variety of materials and methods. In an exemplary embodiment, materials may be of molded plastic material or polymer. More suitably, container insert may be made from injection molding using ABS like material or Thermo-forming using a variety of composite materials.

1. A planter insert comprising:
a. a plurality of container inserts configured to conform to the general inside shape of the planter and substantially fill the top surface area of the planter,
b. wherein at least two of the plurality of container inserts are removably coupled to one another.

2. The planter insert of claim 1 wherein at least two of the plurality of container inserts are removably coupled using a friction fit.

3. The planter insert of claim 1 wherein at least two of the plurality of container inserts are removably coupled using a locking system.

4. The planter insert of claim 1 wherein at least two of the plurality of container inserts are removably coupled using a coupling system.

5. The planter insert of claim 1 wherein the plurality of container inserts further comprise a First Side Portion and a Second Side Portion wherein the First Side Portion of one of the plurality of container inserts is removably coupleable to the Second Side Portion of another of the plurality of container inserts.

6. The planter insert of claim 1 further comprising an extraction system.

7. The planter insert of claim 1 wherein the plurality of container inserts further comprises at least one Third Side Portion that faces the inside wall of the planter

8. The planter insert of claim 1 wherein the plurality of container inserts further comprises a multi-row configuration.

9. The planter insert of claim 1 further comprising an Independent Vessel.

10. The planter insert of claim 1 wherein the plurality of container inserts are configured to stack one within another.

11. The planter insert of claim 1 wherein the plurality of container inserts include plastic.

12. The planter insert of claim 1 further comprising a lip extension.

13. The planter insert of claim 1 wherein the plurality of container inserts are configured with a Front-to-Back Contoured Fit.

14. A planter insert comprising:
A. a plurality of container inserts including a first means for connecting and a second means for connecting,
B. wherein the first means for connecting is configured to removably connect to the second means for connecting enabling one of the plurality of container inserts to be removably connected to another of the plurality of container inserts.

15. The planter insert of claim 14 wherein the plurality of container inserts are configured to conform to the general inside shape of the planter.

16. The planter insert of claim 14 wherein the plurality of container inserts are configured to substantially fill the top surface area of the planter.

17. The planter insert of claim 14 wherein the first means for connecting includes a lip and the second means for connecting includes a hook system.

18. The planter insert of claim 14 wherein the plurality of container inserts include plastic.

19. The planter insert of claim 14 wherein the plurality of container inserts include a support system for drip system tubing.

20. The planter insert of claim 14 wherein the plurality of container inserts include drainage holes.

21. A planting system comprising:
a. a first container insert 20 including a first connecting portion and a second connecting portion, and
b. a second container insert including a first connecting portion and a second connecting portion
c. wherein the first connecting portion of the first container insert is removably connectable to the second connecting portion of the second container insert.

22. The planting system of claim 21 wherein the first connecting portion of the second container insert is removably connectable to the second connecting portion of the first container insert.

23. The planting system of claim 21 further comprising:
a. a third container insert including a first connecting portion and a second connecting portion,
b. wherein the first connecting portion of the second container insert is removably connectable to the second connecting portion of the third container insert.

24. The planting system of claim 23 wherein the first connecting portion of the third container insert is removably connectable to the second connecting portion of the first container insert.

25. The planting system of claim 23 further comprising:
a. a fourth container insert including a first connecting portion and a second connecting portion,
b. Wherein the first connecting portion of the third container insert is removably connectable to the second connecting portion of the fourth container insert.

26. The planting system of claim 25 wherein the first connecting portion of the fourth container insert is removably connectable to the second connecting portion of the first container insert.
